(19) United States
(12) Patent Application Publication
(10) Pub. No.: US 2023/0237820 A1
(43) Pub. Date: Jul. 27, 2023

(54) METHOD AND ELECTRONIC DEVICE FOR OBTAINING TAG THROUGH HUMAN COMPUTER INTERACTION AND PERFORMING COMMAND ON OBJECT

(71) Applicant: Samsung Electronics Co., Ltd., Suwon-si (KR)

(72) Inventors: Yevhenii YAKISHYN, Kyiv (UA); Oleksandr VIATCHANINOV, Kyiv (UA); Oleksandr SHCHUR, Kyiv (UA)

(21) Appl. No.: 18/077,746

(22) Filed: Dec. 8, 2022

Related U.S. Application Data
(63) Continuation of application No. PCT/KR2022/019693, filed on Dec. 6, 2022.

(30) Foreign Application Priority Data
Jan. 25, 2022 (KR) 10-2022-0011063
Jun. 22, 2022 (KR) 10-2022-0076377

(51) Int. Cl. G06V 20/70; G06T 17/00; G06T 7/20; G06T 7/62

(52) U.S. Cl. CPC G06V 20/70; G06T 17/00; G06T 7/20; G06T 7/62; G06V 2201/07

(57) ABSTRACT

A method of performing a command of a user on a target object by using a tag and a visual descriptor of the target object obtained through human computer interaction (HCl) is provided. The method includes obtaining a plurality of images including a target object, detecting a motion of the user manipulating the target object, based on the plurality of images, obtaining a visual descriptor of the target object including visual information for identifying the target object, obtaining a tag of the target object by receiving information related to the target object, by marking the target object, and in response to receiving an input signal corresponding to the tag, performing an operation corresponding to the input signal on the target object, based on the visual descriptor.

### CROSS-REFERENCE TO RELATED APPLICATION(S)

This application is a continuation application, claiming priority under § 365(c), of an International application No. PCT/KR2022/019693, filed on Dec. 6, 2022, which is based on and claims the benefit of a Korean patent application number 10-2022-0011063, filed on Jan. 25, 2022, in the Korean Intellectual Property Office, and of a Korean patent application number 10-2022-0076377, filed on Jun. 22, 2022, in the Korean Intellectual Property Office the disclosure of each of which is incorporated by reference herein in its entirety.

### TECHNICAL FIELD

The disclosure relates to a method by which an electronic device interacts with a user through a human computer interaction (HCl), and an application thereof. More particularly, the disclosure relates to a method and apparatus for performing an operation corresponding to a signal input from a user by using a tag and a visual descriptor of an object, which are obtained through an HCl.

### BACKGROUND

In computing technology, a human computer interaction (HCl) method has been commercialized with the introduction of a smart phone, a tablet computer, a robot, an Internet of things (IoT)-based home appliance, a mobile device, a wearable device, and a device using augmented reality (AR)/mixed reality (MR).

Various types of robots and services are provided according to the increase in demand for electronic devices and services performing auxiliary roles for a user by using HCl in everyday life. There is a service that moves an object to a user or to a specific point or that provides information about an object in response to a question of the user. A video-based HCl method includes obtaining a video through a camera, receiving a user command as an input signal, and processing the user command Such an HCl method may involve interacting with a computer by recognizing a gesture of a user or using a smart tag of an object.

However, most current services using the HCl method have a limitation that a service may be provided only for an object having registered information by recognizing the object in front of a background that is chosen to obtain the information about the object or by manually inputting the information. Also, there is a limitation that it is difficult to specifically classify objects in a same category.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for detecting a motion of a user manipulating an object by using a video camera device, and performing a command on the object by using a tag and a visual descriptor of the object, which are obtained through a human computer interaction (HCl).

In detail, information about an object may be obtained from a motion of a user manipulating the target object, and an operation corresponding to a command may be performed by obtaining a tag of the object through an input signal of the user for objects in a same category.

According to an embodiment of the disclosure, a method and electronic device for obtaining a visual descriptor of a target object and a tag of the target object may be provided.

Additional aspects will be set forth in part in the description which follows and, in part, will be apparent from the description, or may be learned by practice of the presented embodiments.

According to an embodiment of the disclosure, a method, performed by an electronic device, of performing an operation through an interaction with a user is provided. The method includes obtaining a plurality of images including a target object, detecting a motion of the user manipulating the target object, based on the plurality of images, obtaining a visual descriptor of the target object including visual information for identifying the target object, obtaining a tag of the target object by receiving information related to the target object, by marking the target object, and in response to receiving an input signal corresponding to the tag, performing an operation corresponding to the input signal on the target object, based on the visual descriptor.

According to an embodiment of the disclosure, the obtaining of the visual descriptor may include obtaining the visual descriptor in response to the motion of the user being detected within a field of view in which the plurality of images are obtained.

According to an embodiment of the disclosure, the tag of the target object may include information about at least one of a subject who uses the target object, a purpose of the target object, a frequency of use of the target object, an exterior of the target object, or a preference of the user for the target object.

According to an embodiment of the disclosure, the visual descriptor may further include grasping information for providing movement of the target object.

According to an embodiment of the disclosure, the performing of the operation corresponding to the input signal may identifying the target object, based on the visual information included in the visual descriptor, and providing the movement of the target object, based on the grasping information.

According to an embodiment of the disclosure, the visual descriptor may include information indicating at least one of a 3-dimensional (3D) model of the target object, a point cloud of all or a portion of the target object, texture of all or a portion of the target object, a descriptor limited to visual characteristics of the target object, a geometric structure of the target object, or an exterior of the target object.

According to an embodiment of the disclosure, the obtaining of the tag of the target object may include marking the target object using at least one light source, based on the visual descriptor.

According to an embodiment of the disclosure, the obtaining of the tag of the target object may include marking the target object by using at least one augmented reality (AR) projection, based on the visual descriptor.

According to an embodiment of the disclosure, the method may further include determining a location and size of the field of view, and detecting the motion of the user manipulating the target object, based on the field of view.

According to an embodiment of the disclosure, the method may further include storing the visual descriptor in a database, storing the tag in the database, and storing a link between the visual descriptor and the tag in the database.

According to an embodiment of the disclosure, an electronic device for performing an operation through an interaction with a user is provided. The electronic device includes a camera module, a memory storing at least one instruction, and at least one processor configured to execute the at least one instruction stored in the memory to control the camera module to obtain a plurality of images including a target object, detect a motion of the user manipulating the target object in the plurality of images, obtain a visual descriptor of the target object including visual information for identifying the target object, obtain a tag of the target object by receiving information related to the target object, by marking the target object, and in response to receiving an input signal corresponding to the tag, perform an operation corresponding to the input signal on the target object, based on the visual descriptor.

According to an embodiment of the disclosure, a computer program product is provided. The computer program product includes a computer-readable recording medium storing a program including instructions that, when executed by at least one processor, cause the at least one processor to control for obtaining a plurality of images including a target object, detecting a motion of the user manipulating the target object, based on the plurality of images, obtaining a visual descriptor of the target object including visual information for identifying the target object, obtaining a tag of the target object by receiving information related to the target object, by marking the target object, and in response to receiving an input signal corresponding to the tag, performing an operation corresponding to the input signal on the target object, based on the visual descriptor.

### Advantageous Effects of Disclosure

According to the disclosure, an operation corresponding to a command of a user may be performed by using a tag and visual descriptor of an object, instead of a unique name of a target object.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram for describing a method of obtaining a visual descriptor of a target object and a tag of the target object, according to an embodiment of the disclosure;

FIG. 2 is a flowchart of a method of performing an operation corresponding to an input signal, based on a visual descriptor and a tag obtained from a target object, according to an embodiment of the disclosure;

FIG. 3 is a flowchart of a method of performing an operation corresponding to an input signal, based on a visual descriptor and a tag obtained from a target object, according to an embodiment of the disclosure;

FIG. 4 is a diagram for describing an operation by which an electronic device obtains a visual descriptor and a tag, according to an embodiment of the disclosure;

FIG. 5 is a block diagram of an electronic device according to an embodiment of the disclosure;

FIG. 6 is a block diagram of an electronic device according to an embodiment of the disclosure;

FIG. 7 is a diagram for describing processes by which an electronic device detects a motion of a user manipulating a target object, and obtains a visual descriptor of the target object, according to an embodiment of the disclosure;

FIG. 8 is a diagram for describing a process by which an electronic device obtains a visual descriptor, according to an embodiment of the disclosure;

FIG. 9 is a diagram for describing a method by which an electronic device manipulates a target object, based on grasping information, according to an embodiment of the disclosure;

FIG. 10 is a diagram for describing a geometric structure that is a visual descriptor of a target object, according to an embodiment of the disclosure;

FIG. 11 is a diagram for describing a point cloud that is a visual descriptor of a target object, according to an embodiment of the disclosure;

FIG. 12 is a diagram for describing operations of receiving an input signal corresponding to a tag of a target object, based on a visual descriptor, and performing a command, according to an embodiment of the disclosure;

FIG. 13 is a diagram for describing a method of marking a target object, according to an embodiment of the disclosure;

FIG. 14 is a diagram for describing a method of marking a target object, according to an embodiment of the disclosure;

FIG. 15 is a diagram for describing usability of a visual descriptor, according to an embodiment of the disclosure;

FIG. 16 is a diagram for describing augmented reality (AR) using a visual descriptor, according to an embodiment of the disclosure; and

FIG. 17 is a diagram for describing AR using a visual descriptor, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description of embodiments of the disclosure, certain detailed explanations of related art are omitted when it is deemed that they may unnecessarily obscure the essence of the disclosure. Also, numbers (for example, a first, a second, and the like) used in the description of the specification are merely identifier codes for distinguishing one element from another.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of embodiments of the disclosure. Thus, the terms used herein have to be defined based on the meaning of the terms together with the description throughout the specification.

The scope of the disclosure will become apparent from the claims described below rather than the detailed descriptions of the disclosure. Various features mentioned in one claim category (for example, a method claim) of the disclosure may also be claimed in another claim category (for example, a system claim). Also, an embodiment of the disclosure may include not only a combination of features specified in the claims, but also various combinations of individual features in the claims. It should be interpreted that the scope of the disclosure includes the meanings and scope of the claims and all changes and modifications derived from the equivalent concept thereof.

Also, in the disclosure, it will be understood that when elements are “connected” or “coupled” to each other, the elements may be directly connected or coupled to each other, but may alternatively be connected or coupled to each other with an intervening element therebetween, unless specified otherwise. In addition, the elements may be “directly connected” or “physically connected” to each other, or may be “electrically connected” to each other with an intervening element therebetween. In the disclosure, the terms “transmit”, “receive”, and “communicate” include both direct communication and indirect communication.

Throughout the disclosure, when a part “includes” a certain element, the part may further include another element instead of excluding the other element, unless otherwise stated.

In the disclosure, regarding an element represented as a “-er (or)”, “unit”, or a “module”, two or more elements may be combined into one element or one element may be divided into two or more elements according to subdivided functions. A function may be realized through hardware or software, or through a combination of hardware and software. In addition, each element described hereinafter may additionally perform some or all of functions performed by another element, in addition to main functions of itself, and some of the main functions of each element may be performed entirely by another component.

Terms used herein, including technical or scientific terms, may have the same meaning as commonly understood by one of ordinary skill in the art described in the disclosure.

Throughout the disclosure, the term “or” is inclusive and not exclusive, unless otherwise stated. Accordingly, unless differently stated clearly or contextually, “A or B” may include A, B, or both A and B. In the disclosure, the expression “at least one of” or “one or more of” may include different combinations of one or more items in listed items or include only one item among the listed items. For example, “at least one of A, B, or C” may indicate only A, only B, only C, both A and B, both A and C, both B and C, or all of A, B, and C.

The terms used in the disclosure will be briefly defined, and an embodiment of the disclosure will be described in detail.

In the disclosure, “a plurality of images” may denote a still image of a moving image or a video, or a plurality of consecutive still images (or a frame).

Also, in the disclosure, “visual information” may denote a 3-dimensional (3D) model of an object, a point cloud of all or a part of the object, texture of the object, a geometric structure of the object, or an exterior of the object, such as color or size.

Also, in the disclosure, a “visual descriptor” may denote 2-dimensional (2D) scale-invariant feature transform (SIFT), 2D speeded up robust feature (SURF), 2D oriented fast and rotated brief (ORB), 3D point cloud, 3D mesh, signed distance function (SDF), feature vector, 3D primitive or 3D voxel.

In the disclosure, a “field of view” is a range in which an object can be observed, and may denote a range in which a camera can photograph a target object.

Also, in the disclosure, “grasping information” may denote a portion of an object, which comes in contact with a user's body, when the object is held, picked up, or moved.

In the disclosure, a “tag” may denote a keyword or classification assigned to a specific object according to flexible contextual information.

In the disclosure, a “point cloud” is a group of points belonging to a coordinate system, and a 3D point cloud may denote a group of points, which indicates a surface of an object, being represented in x, y, and z coordinates on a 3D coordinate system.

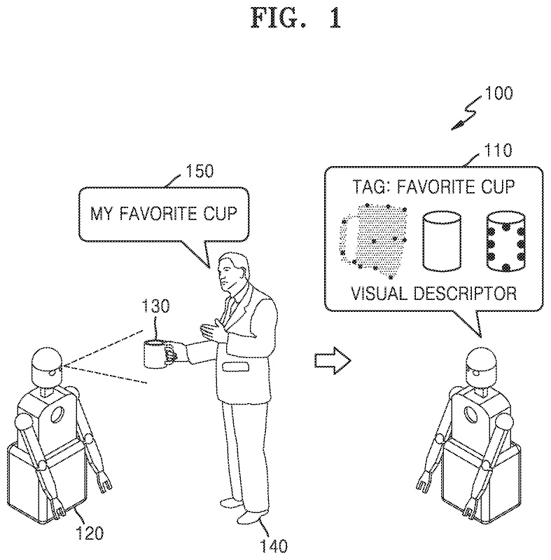

FIG. 1 is a diagram for describing a method of obtaining a visual descriptor of a target object and a tag of the target object, according to an embodiment of the disclosure.

Referring to FIG. 1, the method of obtaining a visual descriptor and tag of a target object, according to an embodiment of the disclosure, may be performed by an electronic device 120. FIG. 1 illustrates a process 100 in which a visual descriptor of a target object 130 and a tag 150 of the target object 130 are obtained at operation 110, through an interaction between the electronic device 120 according to an embodiment of the disclosure and a user 140.

According to an embodiment of the disclosure, the electronic device 120 may be embodied in various forms. For example, the electronic device 120 in the disclosure may be a robot, augmented reality (AR) glasses, mixed reality (MR) glasses, extended reality (XR) glasses, a digital camera, a laptop computer, a tablet personal computer (PC), an electronic book terminal, a digital broadcast terminal, a personal digital assistant (PDA), a portable multimedia player (PMP), or a smart phone, but is not limited thereto. The electronic device 120 described herein may be a wearable device of the user 140. Examples of the wearable device include an accessory type device (for example, a watch, a ring, a wrist band, an ankle band, a necklace, glasses, or a contact lens), a head-mounted device (HMD), a textile or apparel integrated device (for example, electronic clothing), a body-attachable device (for example, a skin pad), and a bio-implant type device (for example, an implantable circuit), but are not limited thereto. Hereinafter, for convenience of descriptions, an example in which the electronic device 120 is a robot will be described in some embodiments of the disclosure.

According to an embodiment of the disclosure, the electronic device 120 may include a camera module (not shown) for obtaining a plurality of images including the target object 130. The electronic device 120 may detect the target object 130 and a motion of the user 140 manipulating the target object 130 from the plurality of images obtained through the camera module, and obtain an input signal and the tag 150 of the target object 130 through the visual descriptor of the target object 130, and an input unit (not shown) at operation 110.

According to an embodiment of the disclosure, the electronic device 120 may obtain the visual descriptor including the visual information of the target object 130 and grasping information of the target object 130, from a motion of the user 140 manipulating the target object 130. Examples of the motion of the user 140 may include a motion of picking up the target object 130, a motion of holding the target object 130, and a motion of lifting and moving the target object 130, but are not limited thereto.

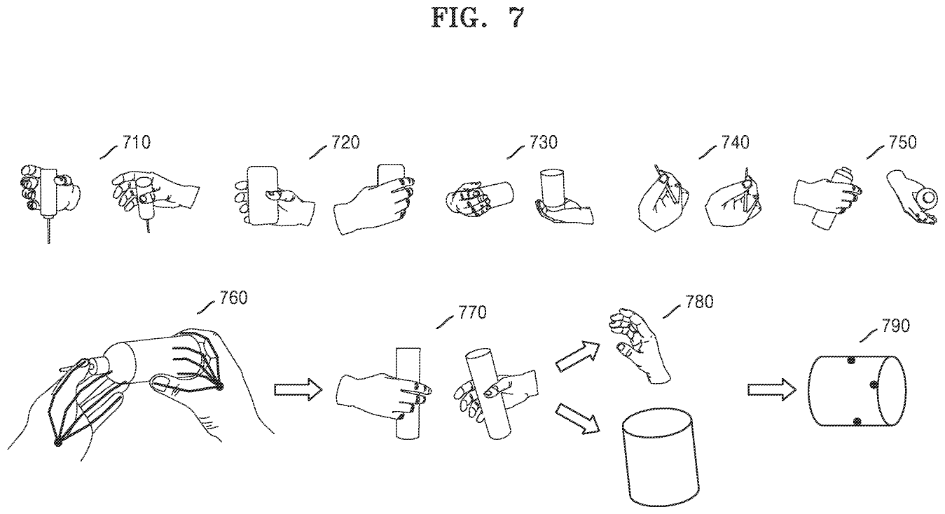

According to an embodiment of the disclosure, the visual descriptor of the target object 130 may include the visual information for distinguishing the target object 130 from other objects in the image and detecting the target object 130. For example, the visual information may include a 3D model of the target object 130, a point cloud of all or a part of the target object 130, texture of all or a part of the target object 130, a geometric structure of the target object 130, or an exterior of the target object 130, such as a color, a size, or a pattern. The visual descriptor may include grasping information for performing an operation corresponding to the input signal. For example, the visual descriptor may include the geometric structure of the target object 130, the center of gravity, and a point where the target object 130 and a hand or the like of the user 140 contact. A method of obtaining the visual descriptor and specific types of the visual descriptor will be described in detail below with reference to FIGS. 7 to 11.

According to an embodiment of the disclosure, the tag 150 of the target object 130 may be used to distinguish the target object 130 from other objects in a same category while performing a command of the user 140 later, because even when objects belong to one category, purposes of the objects and subjects who use the objects may be different from each other. The tag 150 of the target object 130 is differentiated from a general name (for example, a cup, a watch, or a mouse) of an object. The tag 150 of the target object 130 may include information about one or more of a subject who uses the target object 130, a purpose of the target object 130, an exterior (shape, texture, or color) of the target object 130, a frequency of use of the target object 130, and a preference of the user 140 for the target object 130, but is not limited thereto.

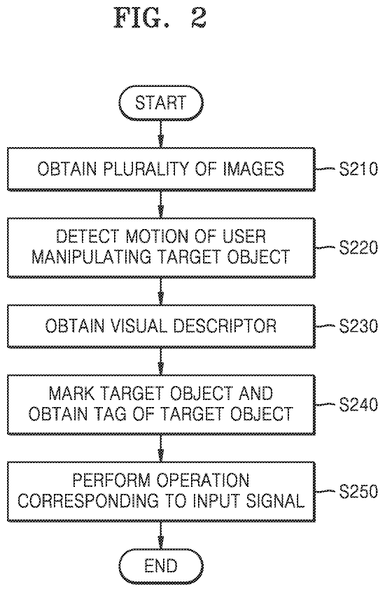

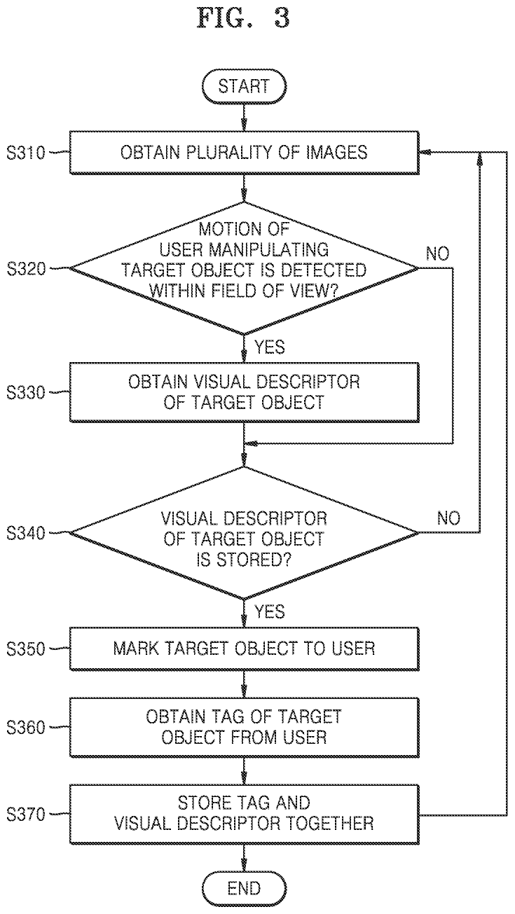

Processes by which the electronic device 120 identifies the target object 130, obtains the visual descriptor of the target object 130 and the tag 150 of the target object 130, and performs an input signal corresponding to the tag 150 will be described in detail with reference to FIGS. 2 and 3.

FIG. 2 is a flowchart of a method of performing an operation corresponding to an input signal, based on a visual descriptor and a tag obtained from a target object, according to an embodiment of the disclosure.

At operation S210, the electronic device 120 may obtain a plurality of images including a target object.

According to an embodiment of the disclosure, the electronic device 120 may obtain the plurality of images including the target object within a determined field of view (FoV).

According to an embodiment of the disclosure, the electronic device 120 may adjust a location and size of the FoV of an image that may include the target object. A method of adjusting the FoV, according to an embodiment of the disclosure, may include adjusting the location and size of the FoV, based on a front portion of the electronic device 120 including a camera module. The size of the FoV may be adjusted horizontally, vertically, or diagonally, but is not limited thereto. Also, the location of the FoV may be changed by using a center point of size adjustment.

At operation S220, the electronic device 120 detects a motion of a user manipulating the target object from the obtained plurality of images. According to an embodiment of the disclosure, the motion of the user may include a motion of holding the target object, a motion of picking up the target object, or an operation of lifting and moving the target object, but is not limited thereto.

At operation S230, a visual descriptor of the target object is obtained. According to an embodiment of the disclosure, the visual descriptor may include any type of data indicating visual or spatial information of the target object. According to an embodiment of the disclosure, the visual descriptor may include visual information for distinguishing the target object from other objects included in the plurality of images, and include grasping information for performing a command on the target object. For example, the visual descriptor may include one of a 3D model of the target object, a point cloud of all or a part of the target object, texture of all or a part of the target object, and a geometric structure or exterior of the target object, and details thereof will be described in detail below with reference to FIG. 7.

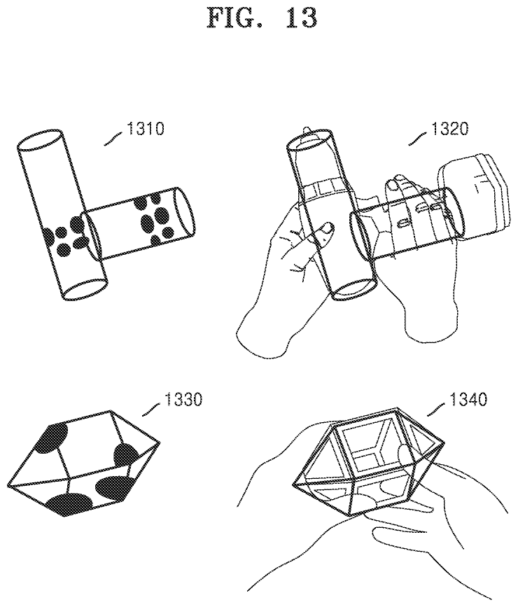

At operation S240, the electronic device 120 marks the target object and obtains a tag of the target object. According to an embodiment of the disclosure, the marking of the target object and obtaining of the tag of the target object are operations of indicating that the visual descriptor of the target object is obtained, marking the target object that is a target of the tag to the user, and obtaining tag information of the target object. According to an embodiment of the disclosure, the target object may be marked by using at least one light source using a beam pointer. A method of projecting the target object by using the light source, or shooting the light source according to the exterior may be used. When the user uses AR, XR, or MR glasses, a method of visually marking the target object by using a bounding box, a mesh, a texturized object, or a pointer, may be used. In case of AR projection, a method of enabling the user to recognize the target object by using a projector may be used, but a method of marking the target object is not limited thereto. For example, a method of physically indicating the target object by using a robot arm may be used. A specific example and embodiment of the disclosure will be described in detail below with reference to FIG. 13.

According to an embodiment of the disclosure, the tag of the target object is for executing a command of the user on the target object, and may be obtained through speech, text, touch, or virtual or actual button manipulation, but is not limited thereto. In the disclosure, the tag of the target object is distinguished from a unique name of an object, and may be related to the user or related to the purpose thereof. For example, the tag may include information about a subject who uses the target object, a purpose of the target object, an exterior (shape, texture, or color) of the target object, a frequency of use of the user regarding the target object, and a preference, but is not limited thereto.

At operation S250, the electronic device 120 performs an operation corresponding to an input signal. According to an embodiment of the disclosure, the input signal regarding the target object may include an operation of moving the target object to a specific point or to the user, or an operation of picking up the target object, but is not limited thereto. According to an embodiment of the disclosure, to perform the command on the target object, the electronic device 120 may receive the input signal corresponding to the tag, identify the target object from among a plurality of objects, based on the visual information included in the visual descriptor, and move the target object based on the grasping information. The input signal corresponding to the tag of the target object may be received through speech, text, touch, or button manipulation, but is not limited thereto.

FIG. 3 is a flowchart of a method of performing an operation corresponding to an input signal, based on a visual descriptor and a tag obtained from a target object, according to an embodiment of the disclosure.

Hereinafter, a method of performing a command based on a tag and visual descriptor obtained from a target object, according to an embodiment of the disclosure, will be described in detail with reference to FIG. 3. Detailed descriptions about operations that overlap those of FIG. 2 will be omitted for brevity of the descriptions.

At operation S310, the electronic device 120 obtains a plurality of images including a target object.

When a motion of a user manipulating the target object is detected within a FoV at operation S320, a next operation is performed.

At operation S330, a visual descriptor of the target object is obtained. According to an embodiment of the disclosure, the visual descriptor of the target object may include visual information for distinguishing the target object from other objects included in the plurality of images, and include grasping information for moving the target object. For example, the visual descriptor may include one of a 3D model of the target object, a point cloud of all or a part of the target object, texture of all or a part of the target object, a geometric structure of the target object, an exterior, the center of gravity, and information about a point of the target object where a body of a user contacts, and this will be described in detail below with reference to FIG. 7.

At operation S340, it is determined whether the visual descriptor of the target object is stored in the electronic device 120. According to an embodiment of the disclosure, the visual descriptor of the target object may be stored in a database.

At operation S350, the electronic device 120 may mark the target object to the user. According to an embodiment of the disclosure, the marking of the target object to the user may denote operations of indicating that the visual descriptor of the target object is obtained, marking the target object that is a target of a tag to the user, and receiving tag information regarding the target object from the user.

At operation S360, the electronic device 120 obtains the tag of the marked target object. According to an embodiment of the disclosure, the tag of the target object is for performing a command of the user later, and may be received through speech, text, touch, or button manipulation. In the disclosure, the tag of the target object is distinguished from a unique name of an object, and may be related to the user or related to the purpose thereof. For example, the tag of the target object may include information about a subject who uses the target object, a purpose of the target object, an exterior (shape, texture, or color) of the target object, a frequency of use of the user regarding the target object, and a preference of the user for the target object, but is not limited thereto.

When the tag of the target object is obtained, the electronic device 120 stores the tag of the target object together with the visual descriptor at operation S370 to use the same for an operation of the electronic device 120 later. According to an embodiment of the disclosure, a method of storing the tag of the target object together with the visual descriptor may include storing the visual descriptor of the target object first in the database, and when the tag of the target object is obtained, storing the tag of the target object in the database. In addition, a link between the visual descriptor of the target object and the tag of the target object is stored in the database. An operation corresponding to an input signal regarding the target object may be performed by using the stored link.

According to an embodiment of the disclosure, when the motion of the user manipulating the target object is not detected within the FoV, it is identified whether the visual descriptor of the target object is stored in the electronic device 120. When the visual descriptor of the target object is not stored or is not newly obtained, the electronic device 120 is used to obtain the plurality of images.

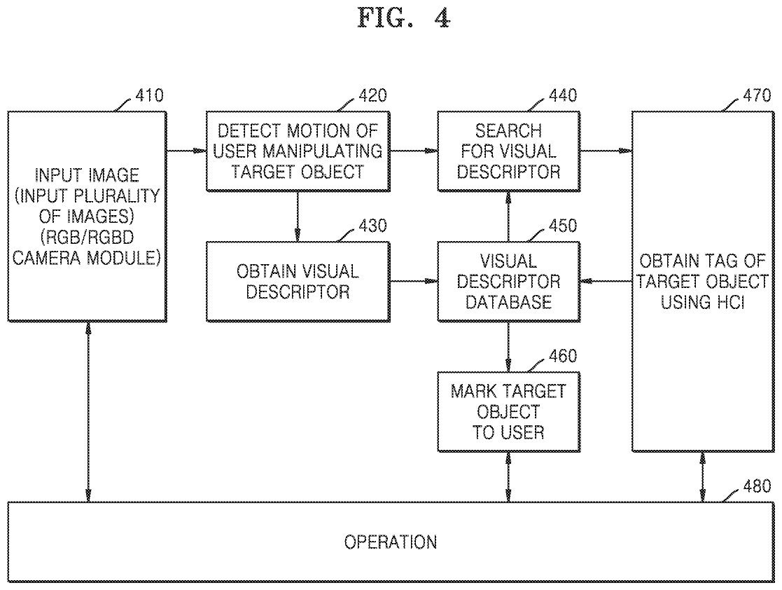

FIG. 4 is a diagram for describing an operation by which an electronic device obtains a visual descriptor and a tag, according to an embodiment of the disclosure.

Referring to FIG. 4, a plurality of images may be obtained by using the electronic device 120 at operation 410. According to an embodiment of the disclosure, the plurality of images may be obtained through a red, green, blue (RGB) or RGB depth (RGBD) camera module.

Among the plurality of images, the electronic device 120 may detect a motion of a user manipulating a target object at operation 420, and obtain a visual descriptor of the target object at operation 430 or search for a stored visual descriptor at operation 440. According to an embodiment of the disclosure, the motion of the user manipulating the target object may include a motion of picking up the target object, holding the target object, or moving the target object. According to an embodiment of the disclosure, the visual descriptor of the target object may include visual information for identifying the target object and grasping information for performing a command on the target object. According to an embodiment of the disclosure, the visual descriptor of the target object may be stored in a database.

The electronic device 120 may mark the target object to the user at operation 460, based on a visual descriptor database 450. According to an embodiment of the disclosure, the marking of the target object may include notifying that the visual descriptor of the target object has been obtained and marking the target object to the user to obtain tag information of the target object. According to an embodiment of the disclosure, the target object may be marked by using at least one light source using a beam pointer. A method of projecting the target object by using the beam pointer, or shooting the light source according to an exterior of the target object may be used. When the user uses AR, XR, or MR glasses, a method of visually marking the target object by using a bounding box, a mesh, a texturized object, or a pointer, may be used. In case of AR projection, a method of enabling the user to recognize the target object by using a projector may be used, but a method of marking the target object is not limited thereto. For example, a method of physically indicating the target object by using a robot arm may be used. A specific example and embodiment of the disclosure will be described in detail below with reference to FIG. 13.

The electronic device 120 may obtain a tag through human computer interaction (HCl) at operation 470. According to an embodiment of the disclosure, the tag of the target object is for executing a command of the user later, and may be obtained through speech, text, touch, or button manipulation, but is not limited thereto. In the disclosure, the tag of the target object is distinguished from a unique name of an object, and may be related to the user or related to the purpose thereof. For example, the tag may include information about a subject who uses the target object, a purpose of the target object, an exterior (shape, texture, or color) of the target object, a frequency of use of the user regarding the target object, and a preference, but is not limited thereto.

The electronic device 120 may perform various operations through an interaction with the user, based on the visual descriptor and the tag of the target object at operation 480. According to an embodiment of the disclosure, the electronic device 120 may receive an input signal corresponding to the tag of the target object, and perform the input signal based on the visual descriptor. For example, the performing of the input signal may include an operation of moving the target object to a designated location, bringing the target object to the user, or picking up the target object.

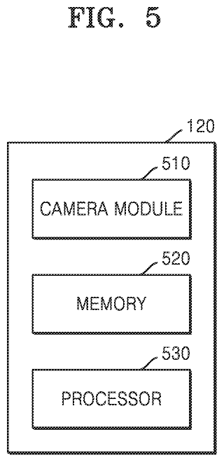

FIG. 5 is a block diagram of an electronic device according to an embodiment of the disclosure.

Referring to FIG. 5, operations of obtaining a visual descriptor and a tag of a target object, and performing a command may be performed by the electronic device 120. The electronic device 120 according to an embodiment of the disclosure may include a camera module 510, a memory 520, and a processor 530. However, not all of the components shown are essential components. The electronic device 120 may be embodied by more or fewer components than those illustrated.

The camera module 510 may obtain a plurality of images including the target object and detect the tag and a motion of a user manipulating the target object. According to an embodiment of the disclosure, the motion of the user detected by the camera module 510 may be a motion of picking up an object, holding an object, or moving an object, and may include a motion of manipulating an object by using a hand According to an embodiment of the disclosure, the camera module 510 may include a plurality of cameras.

According to an embodiment of the disclosure, the camera module 510 may determine a size of FoV for obtaining the plurality of images by adjusting a length at least horizontally, vertically, or diagonally, based on a center of a forward direction of the electronic device 120, and determine a location of the FoV based on a center point of size adjustment.

The memory 520 may store a program command or code executed by the processor 530, or may store input/output data (for example, the plurality of images, a visual descriptor, a tag of an object, and an input signal corresponding to a tag). According to an embodiment of the disclosure, the memory 520 may include a plurality of memories.

The memory 520 may include at least one type of storage medium among a flash memory type, a hard disk type, a multimedia card micro type, a card type memory (for example, a secure digital (SD) or an extreme digital (XD) memory), random access memory (RAM), static RAM (SRAM), read-only memory (ROM), electrically erasable programmable ROM (EEPROM), programmable ROM (PROM), a magnetic memory, a magnetic disk, and an optical disk.

The processor 530 generally controls all operations of the electronic device 120. For example, the processor 530 may execute instructions stored in the memory 520 to determine the FoV of the camera module 510 and detect the motion of the user manipulating the target object. Also, the processor 530 may obtain and store a visual descriptor of the target object and a tag of the target object, receive an input signal corresponding to the tag, and perform an operation corresponding to the input signal. According to an embodiment of the disclosure, the processor 530 may include a plurality of processors.

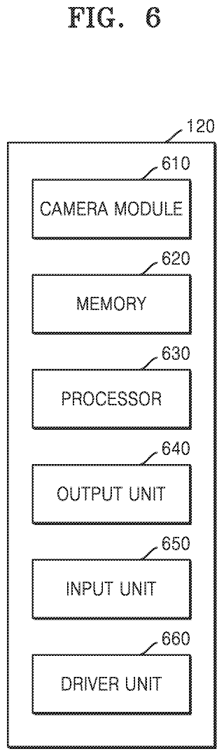

FIG. 6 is a block diagram of an electronic device according to an embodiment of the disclosure.

Referring to FIG. 6, the electronic device 120 according to an embodiment of the disclosure may include an output unit 640, an input unit 650, and a driver unit 660, in addition to the components of the electronic device 120 shown in FIG. 5.

Hereinafter, the above components will be described.

A camera module 610, a memory 620, and a processor 630 may perform operations corresponding to the camera module 510, the memory 520, and the processor 530 of FIG. 5, and thus detailed descriptions thereof are omitted for brevity of descriptions.

The output unit 640 performs an operation for marking a target object to a user. According to an embodiment of the disclosure, the electronic device 120 may mark the target object by using at least one light source using a beam pointer. A method of projecting the target object by using the beam pointer, or shooting the light source according to an exterior of the target object may be used. According to an embodiment of the disclosure, when the user uses AR/MR/XR glasses, the electronic device 120 may mark the target object to the user through a visual effect, such as generating a bounding box around the target object, marking the target object through a mesh, or showing different texture for the target object. A method by which the electronic device 120 marks the target object to the user through the output unit 640 is not limited thereto, and any method that enables the user to recognize an object by drawing the user's attention in a 3D space. For example, when the electronic device 120 is a robot, the target object may be physically marked through a hand of the robot. A specific example and embodiment of the disclosure will be described in detail below with reference to FIG. 13.

According to an embodiment of the disclosure, for marking a target object, the output unit 640 may include a beam pointer, a display of AR, XR, or MR glasses, an AR projector, a robot arm, or the like, but is not limited thereto.

The input unit 650 performs an operation of receiving information about the target object from the user to obtain a tag of the target object, or receiving an input signal corresponding to the tag of the target object. An input of the user may include a speech input, a text input, a touch input, or an input through an actual or virtual button, but is not limited thereto. According to an embodiment of the disclosure, the input unit 650 may include, in response to an input method of the user, a microphone, a keyboard, a touchscreen, or a button, but is not limited thereto.

When the electronic device 120 receives the input signal corresponding to the tag of the target object through the input unit 650, the driver unit 660 performs the operation corresponding to the input signal. The driver unit 660 may use electromotive force, magnetic force, or air pressure, but is not limited thereto, and may perform a linear motion and a rotational motion. For example, when it is commanded to move the target object, the electronic device 120 may control the driver unit 660 to move using a wheel or the like, and move the target object by picking up or lifting the target object through a linear motion and rotational motion.

FIG. 7 is a diagram for describing processes by which the electronic device 120 detects a motion of a user manipulating a target object, and obtains a visual descriptor of the target object, according to an embodiment of the disclosure.

Referring to FIG. 7, according to an embodiment of the disclosure, the electronic device 120 may detect, within an FoV, a motion of a user manipulating a target object. There may be various examples of the motion of the user manipulating the target object, according to a shape or purpose of the target object. A motion of a user manipulating an object may include following examples, but is not limited thereto.

In an example 710 of using contents inside an object (for example, a source container, an adhesive, or a paint), the user manipulates the object by holding a container portion where the contents are contained, instead of an opening of the object where the contents come out. In an example 720 of supporting a rear portion of an object and performing a function of the object through a front portion (for example, a mobile phone or a tablet PC), the object is generally manipulated while a body part of a user contacts the rear portion and a side portion. In an example 730 of putting and using contents inside an object (for example, a cup, a bottle, or a pencil case), the object may be manipulated as a body part of a user contacts an outer surface of the object instead of a portion where the contents are contained. In an example 740 in which an object itself is thin or a portion where a user contacts is thin (for example, a pencil, a straw, or a hose), a proportion of a portion contacted by the user may be large compared to the area of the object, and a contact surface of the object and the user may overlap. In an example 750 of grabbing an object using all of a hand (for example, a water bottle, a can, or a bottle), the object may be manipulated as a body of a user contacts an entire outer surface of the object.

According to an embodiment of the disclosure, the electronic device 120 may detect a motion of a user manipulating a target object at operation 760, and obtain a visual descriptor of the target object at operation 770. According to an embodiment of the disclosure, the visual descriptor of the target object may be a 3D model and may be represented by the target object and a body part of the user manipulating the target object. For example, when the motion of the user manipulating the target object having a cylindrical shape is detected at operation 760, the electronic device 120 may obtain a 3D model of the cylindrical shape that is an outer shape of the target object and a hand of the user from an image at operation 770. The electronic device 120 may segment and recognize a hand shape of the user and the outer shape of the target object from the obtained 3D model at operation 780, and obtain a geometric structure of the target object and grasping information about a point where the hand of the user contacts to manipulate the target object at operation 790.

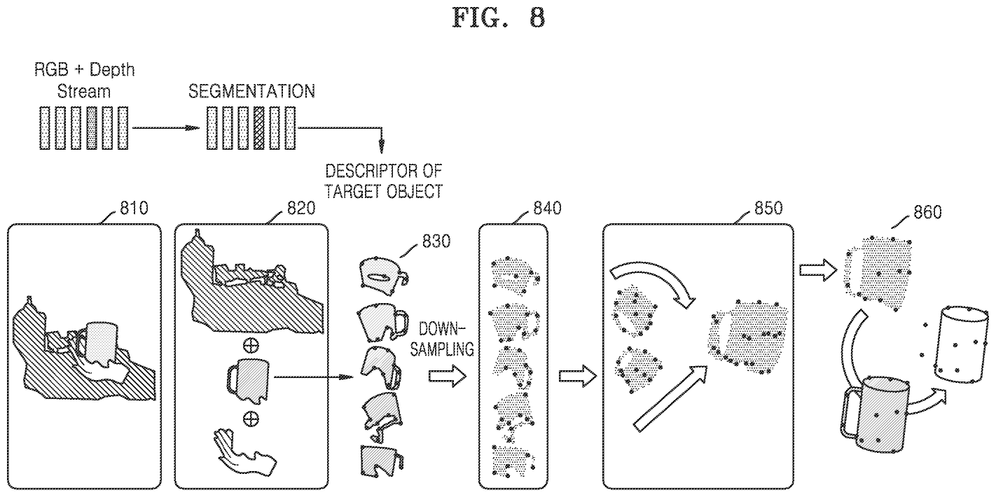

FIG. 8 is a diagram for describing, through a specific example, a process by which the electronic device 120 obtains a visual descriptor of a target object, according to an embodiment of the disclosure.

Referring to FIG. 8, the visual descriptor may include a 3D model of the target object, a point cloud of the target object, a geometric structure of the target object, and a point of the target object where a body part of a user contacts. When a motion of the user manipulating the target object is detected from a plurality of images obtained by the electronic device 120, the electronic device 120 may obtain the visual descriptor of the target object.

According to an embodiment of the disclosure, the electronic device 120 may detect a shape characteristic of the target object from the obtained plurality of images through an RGB stream, and obtain an image in which a distance between the electronic device 120 and the target object is analyzed through a depth stream using time of flight at operation 810. For example, when a hand of a user manipulating a cup is detected, the electronic device 120 may identify a shape characteristic of the cup that is the target object and a shape characteristic of the hand of the user manipulating the cup through the RGB stream, and analyze a distance from the electronic device 120 through the depth stream.

According to an embodiment of the disclosure, the electronic device 120 may segment, from the analyzed image, a background, the target object, and the user's body manipulating the target object through a segmentation stream at operation 820. According to an embodiment of the disclosure, the electronic device 120 may obtain a descriptor of the target object from the segmented plurality of images at operation 830. According to an embodiment of the disclosure, the descriptor of the target object may include a dynamic point cloud as a prior phase of a visual descriptor. For example, after analyzing the user's hand manipulating the cup through the RGB stream and the depth stream, the electronic device 120 may segment the cup that is the target object, the user's hand manipulating the cup, and a background image.

According to an embodiment of the disclosure, a visual descriptor of the target object denotes a state in which several motions of the user manipulating the target object are captured from the plurality of images, and the descriptor is down-sampled after the RGB stream and the segmentation stream. According to an embodiment of the disclosure, the down-sampling of the descriptor of the target object may include generating a dynamic sparse point cloud through down-sampling of a point cloud.

According to an embodiment of the disclosure, the dynamic sparse point cloud and grasping information of the target object may be obtained by performing the down-sampling on the descriptor of the target object at operation 840. According to an embodiment of the disclosure, a point cloud of the target object is points of an exterior of the target object represented in a 3D coordinate system through a 3D scanner. For example, the electronic device 120 may perform the down-sampling on the descriptor of the cup that is the target object. The visual descriptor including the grasping information and dynamic sparse point cloud of the cup may be obtained through the down-sampling.

According to an embodiment of the disclosure, the grasping information and point cloud, which are adjusted in a normal direction of using the target object through rotations in x-, y-, and z-axis directions, may be obtained from the visual descriptor obtained through the down-sampling at operation 850. A geometric structure of the target object and grasping information for manipulating the target object may be obtained from the obtained information at operation 860. For example, the visual descriptor including a cylinder that is a geometric primitive of the cup, a center of gravity thereof, and a point of the cup where the hand contacts may be obtained.

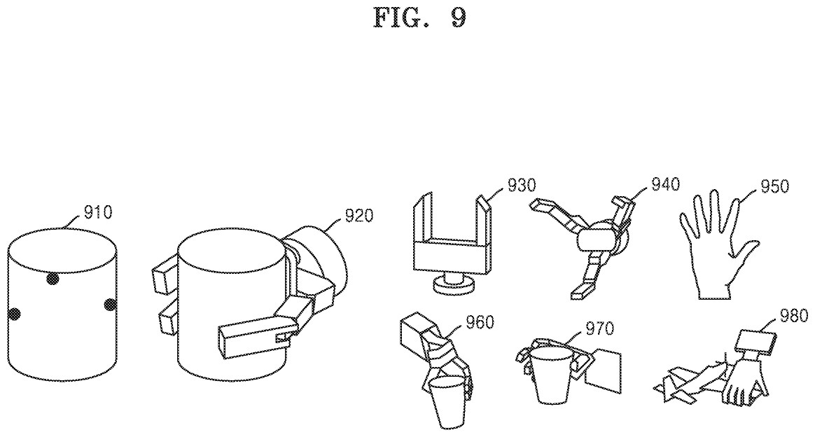

FIG. 9 is a diagram for describing a method by which the electronic device 120 manipulates a target object, based on a visual descriptor, according to an embodiment of the disclosure.

Referring to FIG. 9, according to an embodiment of the disclosure, the electronic device 120 may grab a target object, based on a visual descriptor 910 at operation 920. According to an embodiment of the disclosure, a visual descriptor may include visual information for identifying the target object and grasping information for performing a command corresponding to the target object. The grasping information of the target object may include, for example, a geometric structure of the target object, a center of gravity thereof, and a point where the target object and a hand or the like of a user contact.

According to an embodiment of the disclosure, the grasping information of the target object may include the point where the hand of the user contact, and the electronic device 120 may lift or pick up the target object, based on the grasping information at operation 920. There may be various embodiments of the disclosure for a method by which the electronic device 120 manipulates the target object, depending on a shape of the electronic device 120 or a shape of the target object.

For example, there may be an example 930 in which there are two points where the electronic device 120 and an object contact, and the electronic device 120 do not include a joint in a grasping portion but operates through right and left pressure. Alternatively, there may be an example 940 in which there are three points where the electronic device 120 and an object contact, and the electronic device 120 includes a joint in a grasping portion to manipulate the object. Alternatively, there may be an example 950 in which a portion of the electronic device 120 that performs a command has a similar shape as a hand of a person.

A method of manipulating a target object according to a shape of the target object may include a case 960 where a center of gravity of the target object is at a center portion, a case 970 where a center of gravity is at one side because a target object has a handle or the like, and a case 980 where it is suitable to use an edge of a target object to manipulate the target object, but is not limited thereto.

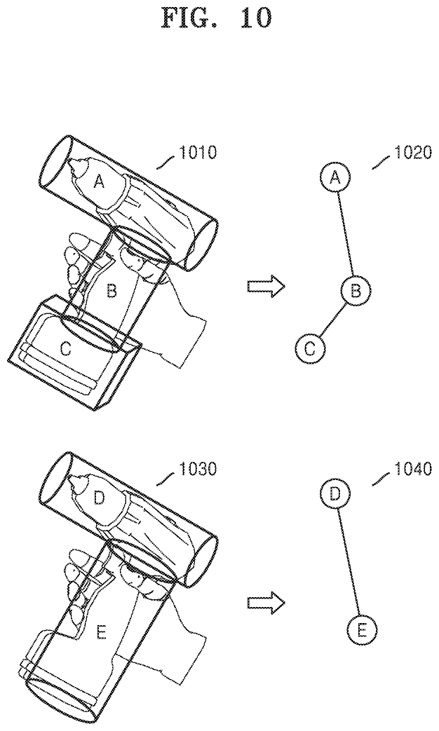

FIG. 10 is a diagram for describing a geometric structure that is a visual descriptor of a target object, according to an embodiment of the disclosure. According to an embodiment of the disclosure, the visual descriptor of the target object includes a geometric structure.

According to an embodiment of the disclosure, a similarity between an actual labeling 1010 and a predicted labeling 1030 may be identified. According to an embodiment of the disclosure, the actual labeling 1010 of the target object may be indicated by an operating portion A, a grasping portion B, and a support portion or charging portion C. A geometric structure 1020 according to the actual labeling 1010 may be segmented and obtained from an image. According to an embodiment of the disclosure, the predicted labeling 1030 of the target object is indicated by an operating portion D and a grasping portion E, and a geometric structure 1040 according to the predicted labeling 1030 may be segmented and obtained.

According to an embodiment of the disclosure, a similarity metric between the geometric structure 1020 based on the actual labeling 1010 and the geometric structure 1040 based on the predicted labeling 1030 may be obtained.

$$Similarity Metric = {\sum }_{i = 1}^{n} {min}_{1 \leq j \leq n} ( \sqrt{{( {a}_{i} - {x}_{j} )}^{2} + {( {b}_{i} - {y}_{j} )}^{2}} + α F ( {U}_{i} , {V}_{j} ) ) \qquad Equation 1$$

(αᵢ, bᵢ) and (xᵢ, yᵢ) are coordinates belonging to different graphs having n vertices. The numbers of vertices may be identically set to n and a vertex distance may be obtained. The vertex distance indicates a relationship between a geometric primitive and a center of mass. F(U₁, V₁) denotes a similarity between features of a geometric primitive and α denotes a balancing constant. The vertex distance to each vertex and the similarity between the features may be obtained based on the centers of mass of the actual labeling 1010 and predicted labeling 1030 by using Equation 1, and a geometric structure of the target object may be stored in a database.

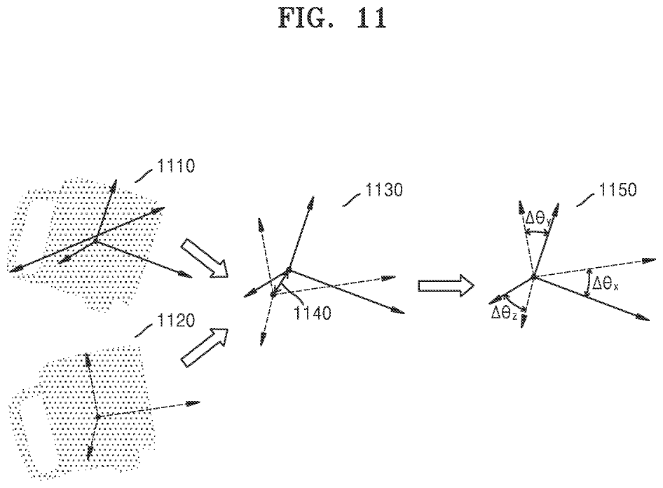

FIG. 11 is a diagram for describing a point cloud that is a visual descriptor of a target object, according to an embodiment of the disclosure. According to an embodiment of the disclosure, the visual descriptor of the target object may include a point cloud of the target object.

Referring to FIG. 11, according to an embodiment of the disclosure, a similarity between a template point cloud 1110 and a registered point cloud 1120 may be obtained.

$$Simliarity = \sqrt{ErrT ⋆ ErrR} \qquad Equation 2$$

$$ErrT = \frac{\sqrt{( Δ {x}^{2} + Δ {y}^{2} + Δ {z}^{2}}}{{D}_{α t}} \qquad Equation 3$$

$$ErrR = \frac{\sqrt{( Δ {θ}_{x}^{2} + Δ {θ}_{y}^{2} + Δ {θ}_{z}^{2} )}}{π} \qquad Equation 4$$

ErrT denotes a normalized translation error and D_{αt} denotes a distance between farthest vertices of the target object. To obtain ErrT, a coordinate axis 1130 is generated by combining coordinate axes of the template point cloud 1110 and registered point cloud 1120. A concentric graph 1150 may be obtained by adjusting a center of a point cloud coordinate from the generated coordinate axis 1130 by a distance 1140 between centers of axes. ErrR is obtained from the concentric graph 1150. ErrR denotes a normalized rotation error and may be obtained by using angle differences θₓ, θ_{y}, θ_{z} for x, y, and z axes. The point cloud of the target object may be stored by using the similarity between the template point cloud 1110 and the registered point cloud 1120 through Equation 2 using ErrR and ErrT.

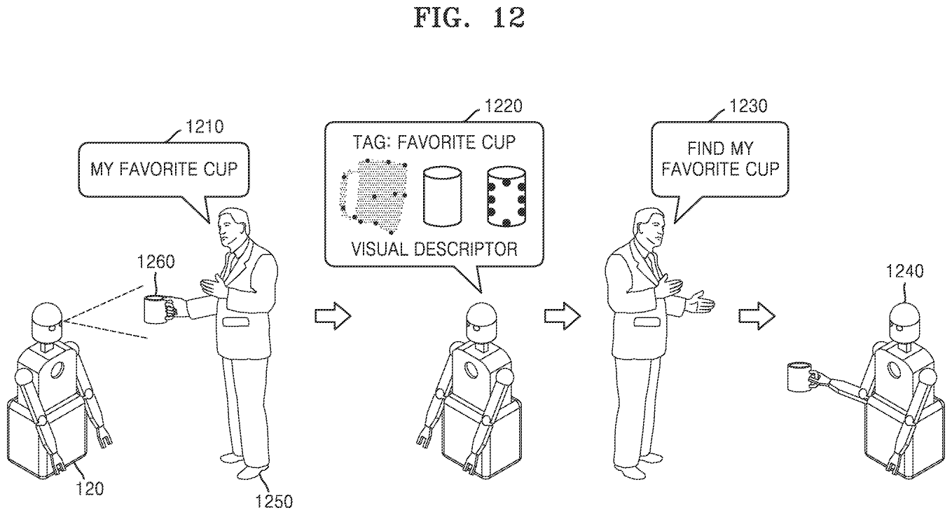

FIG. 12 is a diagram for describing operations of receiving an input signal corresponding to a tag of a target object, based on a visual descriptor, and performing a command, according to an embodiment of the disclosure.

According to an embodiment of the disclosure, the electronic device 120 may obtain a tag 1210 of a target object 1260 from a user 1250. According to an embodiment of the disclosure, the tag 1210 of the target object 1260 may include information about one or more of a subject who uses the target object 1260, a purpose of the target object 1260, an exterior (shape, texture, or color) of the target object 1260, a frequency of use of the target object 1260, and a preference, but is not limited thereto.

According to an embodiment of the disclosure, the electronic device 120 may store, in a database, the tag 1210 of the target object 1260 and a visual descriptor of the target object 1260 at operation 1220. According to an embodiment of the disclosure, the electronic device 120 may store, in the database, the visual descriptor of the target object 1260 and the tag 1210 of the target object 1260. Then, the electronic device 120 may store, in the database, a link between the visual descriptor of the target object 1260 and the tag 1210 of the target object 1260, and use the link when performing an operation for an input signal corresponding to the tag 1210 of the target object 1260.

According to an embodiment of the disclosure, the electronic device 120 may receive the input signal corresponding to the tag 1210 of the target object 1260 from the user 1250 at operation 1230. According to an embodiment of the disclosure, the input signal corresponding to the tag 1210 of the target object 1260 may include an operation of picking up, holding, or moving the target object 1260, but is not limited thereto. According to an embodiment of the disclosure, the input signal corresponding to the tag 1210 of the target object 1260 may be received through speech, text, touch, or button manipulation, but is not limited thereto. According to an embodiment of the disclosure, the electronic device 120 may receive the input signal corresponding to the tag 1210 of the target object 1260 through an input unit (for example, a microphone, a touchscreen, or a button).

According to an embodiment of the disclosure, the electronic device 120 may perform an operation corresponding to the input signal on the target object 1260 at operation 1240. According to an embodiment of the disclosure, the operation corresponding to the input signal may include an operation of picking up the target object 1260, holding the target object 1260, moving the target object 1260 to a specific point, or moving the target object 1260 to the user 1250.

FIG. 13 is a diagram for describing a method of marking a target object, according to an embodiment of the disclosure. According to an embodiment of the disclosure, the method of marking a target object may include a method of visually marking the target object by using a bounding box, a mesh, a texturized object, or a pointer, when a user uses AR glasses, XR glasses, or MR glasses.

Referring to FIG. 13, when a user is wearing AR, XR, or MR glasses, the electronic device 120 may mark, on a display, a geometric structure 1320 of a target object so as to obtain a tag of the target object by receiving information 1310 related to the target object. According to an embodiment of the disclosure, the electronic device 120 may also mark grasping information in addition to the geometric structure of the target object, based on a visual descriptor 1330 including the grasping information as well as the geometric structure 1340 of the target object.

According to an embodiment of the disclosure, when the user wearing the AR, XR, or MR glasses moves or a hand holding the target object is moved, the mark of the geometric structure or grasping information of the target object may be adjusted according to movement of the target object.

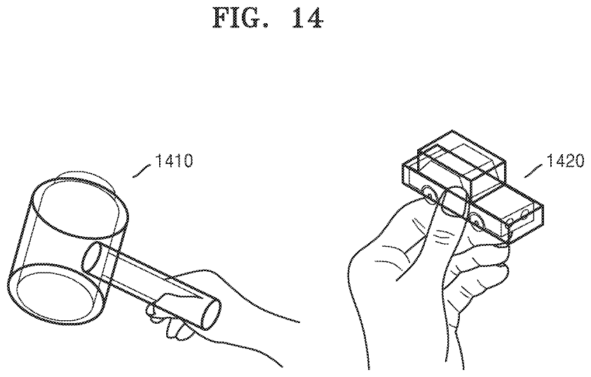

FIG. 14 is a diagram for describing a method of marking a target object, according to an embodiment of the disclosure.

Referring to FIG. 14, while marking a target object according to an embodiment of the disclosure, the electronic device 120 may distinguish, based on a visual descriptor, between a portion of the target object contacted by a user and a portion of the target object not contacted by the user, or between an operating portion and non-operating portion of the target object, and mark the portions in different colors. According to an embodiment of the disclosure, a geometric structure included in the visual descriptor may include a geometric primitive (for example, a cylinder, a rectangular parallelepiped, a sphere, or a cone) at operations 1410 and 1420.

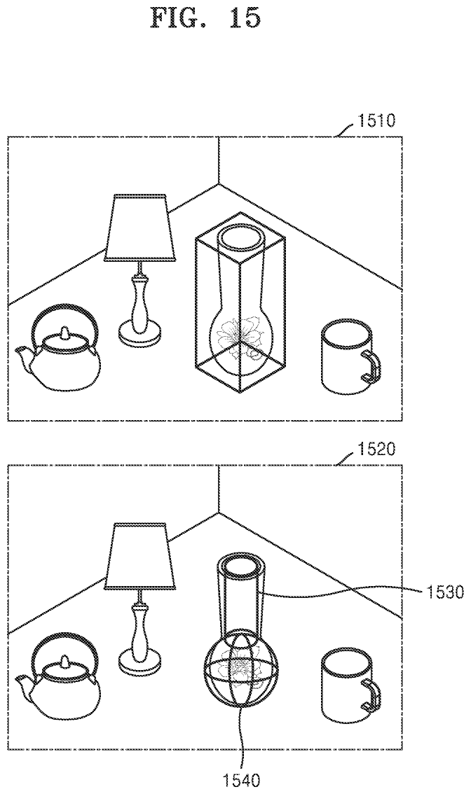

FIG. 15 is a diagram for describing usability of a visual descriptor, according to an embodiment of the disclosure. A general method 1510 of marking a target object by using a bounding box is implemented by a rectangular parallelepiped box surrounding the entire target object.

According to an embodiment of the disclosure, a method 1520 of marking a target object through a bounding box by using a visual descriptor of the target object may consider a geometric structure of the target object. The general method 1510 of marking a rectangular parallelepiped entirely surrounding the target object has a limitation that a background portion other than the target object is included, but the method 1520 of marking a target object, according to an embodiment of the disclosure, may accurately mark only the target object based on the visual descriptor.

According to an embodiment of the disclosure, when an exterior of the target object has a shape in which a cylinder and a sphere are combined, the general method 1510 identifies the target object and marks the target object by using a rectangular parallelepiped bounding box surrounding both the cylinder and the sphere. According to the method 1520 of the disclosure, shapes of a cylinder 1530 and a sphere 1540 are accurately marked, based on the visual descriptor including the geometric structure of the target object, and thus portions other than the target object are not included in the bounding box.

According to an embodiment of the disclosure, when the target object is used in a virtual space through AR, XR, or MR by determining the exterior of the target object based on the visual descriptor, it is possible to synthesize accurate graphic or precisely manipulate the target object.

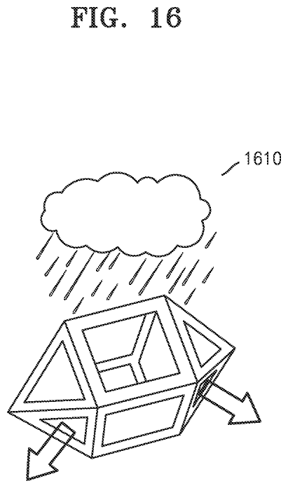

FIG. 16 is a diagram for describing AR using a visual descriptor, according to an embodiment of the disclosure.

Referring to FIG. 16, according to an embodiment of the disclosure, when a user wears AR, MR, or XR glasses, AR may be realized based on a visual descriptor of a target object. According to an embodiment of the disclosure, when the visual descriptor of the target object is obtained, an additional graphic operation may be performed on the target object by executing an application or instruction at operation 1610. The graphic operation may include an animation associated with the target object. According to an embodiment of the disclosure, AR may be realized after obtaining a visual descriptor of a toy. A rain cloud may be combined above the toy and an arrow may be combined on a side of the toy, based on the visual descriptor accurately including exterior information of the toy.

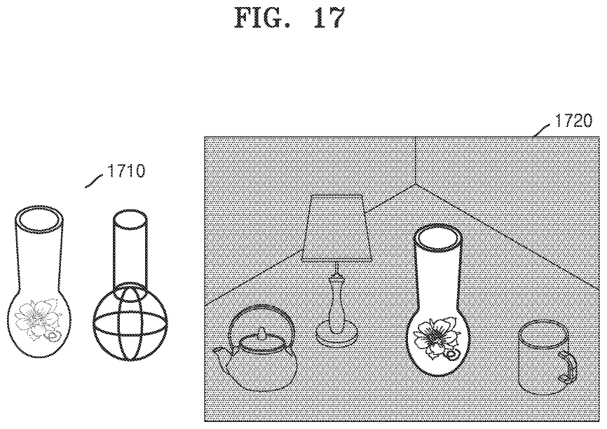

FIG. 17 is a diagram for describing AR using a visual descriptor, according to an embodiment of the disclosure.

Referring to FIG. 17, when information about a target object is obtained, based on a visual descriptor of the target object at operation 1710, an actual object may be added to virtual reality (VR) at operation 1720. According to an embodiment of the disclosure, by adding the actual object to VR, MR may be realized through an interaction of manipulating an object. For example, a visual descriptor of a vase that is a target object, the visual descriptor including a geometric primitive (a cylinder and a sphere), and an exterior of the target object (a color, a pattern, and texture), may be obtained. The vase may be combined at a desired place in AR and manipulated, based on the obtained visual descriptor.

Meanwhile, the embodiments of the disclosure described above may be written as computer-executed programs or instructions, and the written programs or instructions may be stored in a medium.

A method according to various embodiments of the disclosure may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store (for example, Play Store™) or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

While one or more embodiments of the disclosure have been described with reference to the figures, it will be understood by one of ordinary skill in the art that various changes in form and details may be made therein without departing from the scope as defined by the following claims.

A machine-readable storage medium may be provided in a form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by an electronic device, of performing an operation through an interaction with a user, the method comprising:
obtaining a plurality of images including a target object;
detecting a motion of the user manipulating the target object, based on the plurality of images;
obtaining a visual descriptor of the target object including visual information for identifying the target object;
obtaining a tag of the target object by receiving information related to the target object, by marking the target object; and
in response to receiving an input signal corresponding to the tag, performing an operation corresponding to the input signal on the target object, based on the visual descriptor.

2. The method of claim 1, wherein the obtaining of the visual descriptor comprises obtaining the visual descriptor, in response to the motion of the user being detected within a field of view in which the plurality of images are obtained.

3. The method of claim 2, further comprising:
determining a location and a size of the field of view; and
detecting the motion of the user manipulating the target object, based on the field of view.

4. The method of claim 1, wherein the tag of the target object comprises information about at least one of:
a subject who uses the target object,
a purpose of the target object,
a frequency of use of the target object,
an exterior of the target object, or
a preference of the user for the target object.

5. The method of claim 1, wherein the visual descriptor further comprises grasping information for providing movement of the target object.

6. The method of claim 5, wherein the performing of the operation corresponding to the input signal comprises:
identifying the target object, based on the visual information included in the visual descriptor; and
providing the movement of the target object, based on the grasping information.

7. The method of claim 1, wherein the visual descriptor comprises information indicating at least one of:
a 3-dimensional (3D) model of the target object,
a point cloud of all or a portion of the target object,
texture of all or a portion of the target object,
a descriptor limited to visual characteristics of the target object,
a geometric structure of the target object, or
an exterior of the target object.

8. The method of claim 1, wherein the obtaining of the tag of the target object comprises marking the target object by using at least one light source, based on the visual descriptor.

9. The method of claim 1, wherein the obtaining of the tag of the target object comprises marking the target object using at least one augmented reality (AR) projection, based on the visual descriptor.

10. The method of claim 1, further comprising:
storing the visual descriptor in a database;
storing the tag of the target object in the database; and
storing a link between the visual descriptor and the tag of the target object in the database.

11. An electronic device for performing an operation through an interaction with a user, the electronic device comprising:
a camera module;
a memory storing at least one instruction; and
at least one processor configured to execute the at least one instruction stored in the memory to:
control the camera module to obtain a plurality of images including a target object,
detect a motion of the user manipulating the target object in the plurality of images,
obtain a visual descriptor of the target object including visual information for identifying the target object,
obtain a tag of the target object by receiving information related to the target object, by marking the target object; and
in response to receiving an input signal corresponding to the tag, perform an operation corresponding to the input signal on the target object, based on the visual descriptor.

12. The electronic device of claim 11, wherein the at least one processor is further configured to execute the at least one instruction to obtain the visual descriptor in response to the motion of the user being detected within a field of view in which the plurality of images are obtained.

13. The electronic device of claim 12, wherein the at least one processor is further configured to execute the at least one instruction to:
determine a location and size of the field of view, and
detect the motion of the user manipulating the target object, based on the field of view.

14. The electronic device of claim 11, wherein the tag of the target object comprises information about at least one of:
a subject who uses the target object,
a purpose of the target object,
a frequency of use of the target object,
an exterior of the target object, or
a preference of the user for the target object.

15. The electronic device of claim 11, wherein the visual descriptor further comprises grasping information for providing movement of the target object.

16. The electronic device of claim 15, wherein the at least one processor is further configured to execute the at least one instruction to:
identify the target object, based on the visual information included in the visual descriptor; and
provide the movement of the target object, based on the grasping information.

17. The electronic device of claim 11, wherein the visual descriptor comprises at least one of:
a 3-dimensional (3D) model of the target object,
a point cloud of all or a portion of the target object,
texture of all or a portion of the target object,
a descriptor limited to visual characteristics of the target object,
a geometric structure of the target object, or
an exterior of the target object.

18. The electronic device of claim 11, wherein the at least one processor is further configured to execute the at least one instruction to mark the target object using at least one of at least one light source or at least one augmented reality (AR) projection, based on the visual descriptor.

19. The electronic device of claim 11, wherein the at least one processor is further configured to execute the at least one instruction to:
store the visual descriptor in a database;
store the tag of the target object in the database; and
store a link between the visual descriptor and the tag in the database.

20. A non-transitory computer-readable recording medium having recorded thereon a program including instructions that, when executed by at least one processor, cause the at least one processor to control for:
obtaining a plurality of images including a target object;
detecting a motion of a user manipulating the target object, based on the plurality of images;
obtaining a visual descriptor of the target object including visual information for identifying the target object;
obtaining a tag of the target object by receiving information related to the target object, by marking the target object; and
in response to receiving an input signal corresponding to the tag, performing an operation corresponding to the input signal on the target object, based on the visual descriptor.
